(19) United States
(12) Patent Application Publication
(10) Pub. No.: US 2008/0170620 A1
(43) Pub. Date: Jul. 17, 2008

(54) VIDEO ENCODING SYSTEM

(75) Inventor: Ximin Zhang, San Jose, CA (US)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 11/623,954

(22) Filed: Jan. 17, 2007

(51) Int. Cl. H04N 7/12; H04N 11/02

(52) U.S. Cl. 375/240.18; 382/248; 375/E07.026; 375/E07.226

(57) ABSTRACT

A video encoding system is provided including analyzing a picture; providing transforms; selecting a transform from the transforms by comparing a luminance characteristic of the picture with a human visual system texture criterion of the picture; and applying the transform for encoding and displaying the picture.

### TECHNICAL FIELD

The present invention relates generally to video coding systems, and more particularly to a system for advanced video coding compatible with the H.264 specification.

### BACKGROUND ART

High Definition video processing has migrated into all aspects of communication and entertainment. The modern consumer expects the delivery of HD video to cell phones, the high definition television programming, and the view through the window provided by DVD movies. Many of the high definition broadcasts are bringing a realism that can only be matched by looking through a real window to watch the actual event unfold before you.

In order to make the transfer of high definition video more efficient, different video coding schemes have tried to get the best picture from the least amount of data. The Moving Pictures Experts Group (MPEG) has created standards that allow an implementer to supply as good a picture as possible based on a standardized data sequence and algorithm. The emerging standard H.264 (MPEG4 Part 10)/Advanced Video Coding (AVC) design delivers an improvement in coding efficiency typically by a factor of two over MPEG-2, the most widely used video coding standard today. The quality of the video is dependent upon the manipulation of the data in the picture and the rate at which the picture is refreshed. If the rate decreases below about 30 pictures per second, the human eye can detect “unnatural” motion.

Due to coding structure of the current video compression standard, the picture rate-control consists of three steps: 1. Group of Pictures (GOP) level bit allocation; 2. Picture level bit allocation; and 3. Macro block (MB) level bit allocation. The picture level rate control involves distributing the GOP budget among the picture frames to achieve a maximal and uniform visual quality. Although Peak Signal to Noise Ratio (PSNR) does not fully represent the visual quality, it is most commonly used to quantify the visual quality. However, it is noticed that the AVC encoder is intended to blur the fine texture details even in relative high bit-rate. Although AVC can obtain better PSNR, this phenomenon adversely influences the visual quality for some video sequences.

A GOP is made up of a series of pictures starting with an Intra picture. The Intra picture is the reference picture that the GOP is based on. It may represent a video sequence that has a similar theme or background. The Intra picture requires the largest amount of data because it cannot predict from other pictures and all of the detail for the sequence is based on the foundation that it represents. The next picture in the GOP may be a Predicted picture or a Bidirectional predicted picture. The names may be shortened to I-picture, P-picture and B-picture or I, P, and B. The P-picture has less data content that the I-picture and some of the change between the two pictures is predicted based on certain references in the picture.

The use of P-pictures maintains a level of picture quality based on small changes from the I-picture. The B-picture has the least amount of data to represent the picture. It depends on information from two other pictures, the I-picture that starts the GOP and a P-picture that is within a few pictures of the B-picture. The P-picture that is used to construct the B-picture may come earlier or later in the sequence. The B-picture requires “pipeline processing”, meaning the data cannot be displayed until information from a later picture is available for processing.

In order to achieve the best balance of picture quality and picture rate performance, different combinations of picture sequences have been attempted. The MPEG-2 standard may use an Intra-picture followed by a Bidirectional predicted picture followed by a Predicted picture (IBP). The combination of the B-picture and the P-picture may be repeated as long as the quality is maintained (IBPBP). When the scene changes or the quality and/or picture rate degrades, another I-picture must be introduced into the sequence, starting a new GOP.

Among many important techniques in the AVC standard, de-blocking filters and 4×4 transforms play an important role to improve the compression efficiency. According to the history of the AVC standard, these tools were optimized for low bit-rate and low resolution, Quarter Common Intermediate Format (QCIF) and Common Intermediate Format (CIF) video sequences. When the focus was transferred to high resolution, Standard Definition (SD) and High Definition (HD) video sequences, the de-blocking filters and 4×4 transforms naturally became revision targets. Following this trend, 8×8 transform and quantization weighting matrices have been adopted by the Professional Extensions Profile of the AVC standard.

Most of the work on adaptive transform type selection focuses how to obtain better PSNR by using the same bit rate, or how to keep same PSNR by using a lower bit rate. Although this approach can improve the visual quality, it is not optimal from the point of view of the human visual system (HVS). The HVS is a luminance and contrast profile that represents human visual processing. The AVC standard mandates that one picture can only select one quantization weighting matrix. For a picture showing similar characteristics in all areas, a quantization weighting matrix can achieve very good results. However, for a picture that shows dramatically different characteristics in different areas, the use of a common quantization weighting matrix may actually degrade the encoding performance.

Thus, a need still remains for a video encoding system that can deliver high quality video to the high definition video market. In view of the ever-increasing demand for high definition video, it is increasingly critical that answers be found to these problems. In view of the ever-increasing commercial competitive pressures, along with growing consumer expectations and the diminishing opportunities for meaningful product differentiation in the marketplace, it is critical that answers be found for these problems as soon as possible.

Solutions to these problems have long been sought but prior developments have not taught or suggested any solutions and, thus, solutions to these problems have long eluded those skilled in the art.

### DISCLOSURE OF THE INVENTION

The present invention provides a video encoding system including analyzing a picture; providing transforms; selecting a transform from the transforms by comparing a luminance characteristic of the picture with a human visual system texture criterion of the picture; and applying the transform for encoding and displaying the picture.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram of a video encoding system, in an embodiment of the present invention;

FIG. 2 is a group of pictures as might be processed by the video encoding system of the present invention;

FIG. 3 is a diagram of a macro block in a de-blocking filtering process;

FIG. 4 is a diagram of the macro block in a human visual system texture analysis process;

FIG. 5 is a diagram of a group of quantization weighting matrices for transforms;

FIG. 6 is a graph of the texture vs. the luminance for the human visual system texture analysis window;

FIG. 7 is a flow chart of a video encoding system for operating the video encoding system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or physical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGS. Where multiple embodiments are disclosed and described, having some features in common, for clarity and ease of illustration, description, and comprehension thereof, similar and like features one to another will ordinarily be described with like reference numerals.

For expository purposes, the term “system” means the method and the apparatus of the present invention.

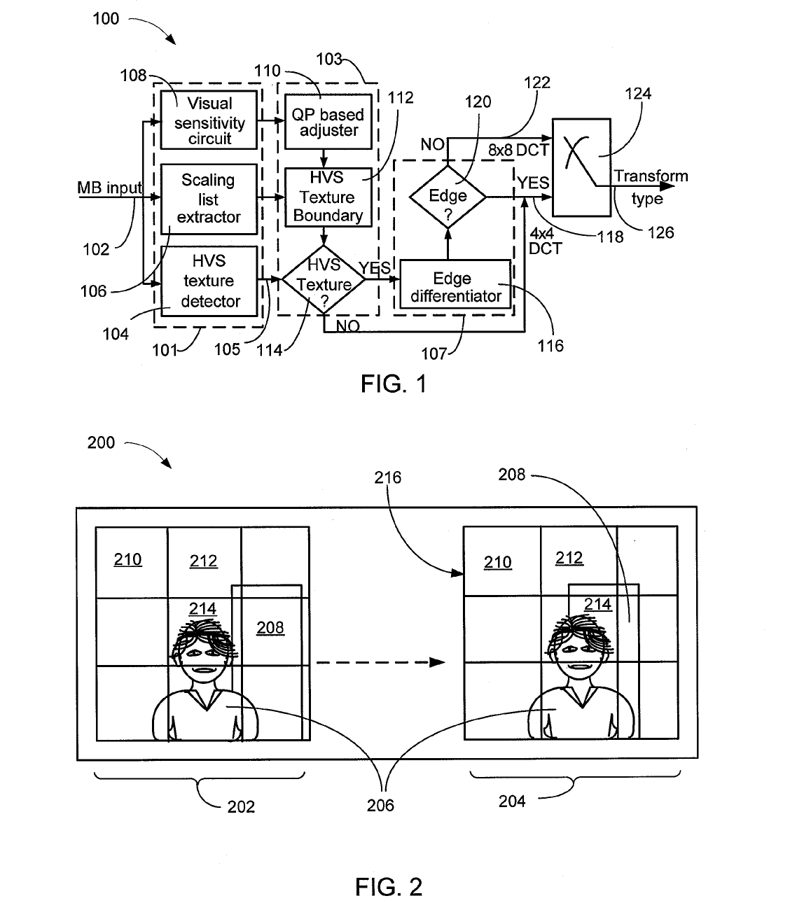

Referring now to FIG. 1, therein is shown a block diagram of a video encoding system 100, in an embodiment of the present invention. The block diagram depicts an input sense module 101, a compensation module 103, a differentiator module 107, and a transform switch 124. The input sense module 101, such as in input sense circuitry, receives the information from a macro block input bus 102. The compensation module 103, such as a compensation circuitry, receives the processed information to formulate a texture output 105, such as a human visual system texture, from the input sense module 101 and adjusts the information, by determining the intensity of a transform, as a part of the encoding process. The compensation module 103 interprets the information from the input sense module 101 for selecting a light transform, such as an 8×8 transform, or a heavy transform, such as a 4×4 transform. The differentiator module 107, such as a differentiator circuitry, further processes the compensation information from the compensation module 103 for continuing the encoding process.

The input sense module 101 includes a human visual system (HVS) texture detector 104, a scaling list extractor 106, and a visual sensitivity circuit 108. The compensation module 103 includes a quantization parameter (QP) based adjuster 110, a human visual system (HVS) texture boundary circuit 112, and A human visual system (HVS) texture comparator 114. The differentiator module 107 includes an edge differentiator circuit 116 and an edge comparator 120.

In more detail, the video encoding system 100 depicts the macro block input bus 102 coupled to the HVS texture detector 104 having the texture output 105, the scaling list extractor 106, and the visual sensitivity circuit 108. The contents of a macro block are submitted through the macro block input bus 102 to the HVS texture detector 104 for analysis of the area with observable luminance texture contrast. Luminance is a photometric measure of the density of luminous intensity in a given direction. It describes the amount of light that passes through or is emitted from a particular area, and falls within a given solid angle.

The HVS texture detector 104 monitors the local variance of the luminance as a measure of texture. Before the encoding of each macro block, it is divided into four quadrants or 8×8 blocks. The variance of the luminance of each quadrant is calculated. A maximum quadrant variance of the luminance and a minimum quadrant variance of the luminance are stored. The minimum quadrant variance of the luminance among the four 8×8 blocks is used as the texture value of the macro block being analyzed. The magnitude of the texture output 105 indicates the magnitude of the variance of the luminance, such as the human visual system texture.

The scaling list extractor 106 examines the scaling information, such as the quantization weighting matrix, to set limits for texture detection. The visual sensitivity circuit 108 presents an analysis of the background luminescence by generating an upper bound and an lower bound based on average luminance within the macro block being analyzed. The output of the visual sensitivity circuit 108 is passed to the QP based adjuster 110. The QP based adjuster 110 formulates adjustments to the upper bound and the lower bound generated by the visual sensitivity circuit 108. The HVS texture boundary circuit 112 receives scaling information from the scaling list extractor 106 and the bounds information from QP based adjuster 110 to establish the profiles for the upper bound and the lower bound.

The QP based adjuster 110 adjusts the lower bound by holding the lower bound constant at a first fixed level if the quantization parameter is in a first range of less than 18. If a second range has the quantization parameter between 18 and 38, the lower bound increases linearly. If a third range has the quantization parameter greater than 38, the lower bound is held at a second fixed level. The QP based adjuster 110 also adjusts the upper bound by holding the upper bound at an initial value in a first region having the quantization parameter less than 18. In a second region the quantization parameter is between 18 and 38, the upper bound is increased in a three step piece-wise linear function. The piece-wise linear function approximates a curve with three straight lines. A third region having the quantization parameter greater than 38 holds the upper bound at a second fixed value.

The HVS texture comparator 114 compares the variance of the luminance value presented by the HVS texture detector 104 to the upper bound and the lower bound generated from the scaling list extractor 106 and the QP based adjuster 110. If the HVS texture comparator 114 confirms that, the macro block being analyzed does contain a sufficient amount of HVS texture to fit between the upper bound and the lower bound, the YES output of the HVS texture comparator 114 transfers information to the edge differentiator circuit 116. If the HVS texture is above the upper bound or below the lower bound, the NO output of the HVS texture comparator 114 asserts a heavy transform select line 118, such as a 4×4 transform select line.

The edge differentiator circuit 116 compares the maximum variance of the luminance and the minimum variance of the luminance detected in the macro block. If the maximum variance of the luminance is more than three times the value of the minimum variance of the luminance, an edge is detected. The information is passed to the edge comparator 120. If an edge is detected by the edge comparator 120, the YES output of the edge comparator is activated, asserting the heavy transform select line 118. If an edge is not detected by the edge comparator 120, the NO output is activated, asserting a light transform select line 122, such as an 8×8 transform select line. The transform switch 124 responds to the heavy transform select line 118 or the light transform select line 122. The transform switch 124 activates a transform type select line 126 that selects an 8×8 quantization weighting matrix or a 4×4 quantization weighting matrix for further processing of the picture. The quantization weighting matrix maps the high frequency attenuation process in order to support the human visual system and deliver more low frequency content.

Referring now to FIG. 2, therein is shown a group of pictures 200 as might be processed by the video encoding system 100 of the present invention. The group of pictures 200 depicts an Intra picture 202 on the left side of the group of pictures 200 and a subsequent picture 204 on the right side of the group of pictures 200. The subsequent picture 204 may be a “P” picture or a “B” picture and there may be additional pictures either before or after the subsequent picture 204.

A foreground object 206, such as a person, vehicle, or building, is centered in the lower frame of the Intra picture 202. A background object 208, such as a sign, a vehicle, or a person is located at the far right side of the Intra picture 202. In the subsequent picture 204, the foreground object has not moved relative to the Intra picture 202, but the background object 208 has moved from the far right in the Intra picture 202 to the right center in the subsequent picture 204.

The group of pictures 200 is a very simplified example and in actual practice, each of the Intra picture 202 or the subsequent picture 204 may have thousands of objects within their boundaries. For purposes of this example, a single moving background object is used to explain the operation of the video encoding system 100.

Each of the Intra picture 202 and the subsequent picture 204 are divided into segments. A reference segment 210, such as an edge macro block, in the Intra picture 202 is processed by the video encoding system 100 in order to establish an initial reference for the group of pictures 200. A next segment 212, such as a non-texture macro block, is processed in successive order to complete the Intra picture 202.

The subsequent picture 204 is processed in a similar fashion as the Intra picture 202. As the reference segment 210 and the next segment 212 of the subsequent picture 204 are processed, changes in the reference segment 210 and the next segment 212 are stored. In the current example, the movement of the background object 208 is detected in several of the next segment 212. The changes are processed to generate and store information about the movement of objects in the next segment 212.

A central segment 214, such as a human visual system texture macro block, may contain a variance of the luminance known as texture. The reference segment 210 may be designated as an edge block when it is detected as having an edge 216 of the subsequent picture 204. As the reference segment 210 is detected as having the edge 216, the analysis would switch the heavy transform select line 118 of FIG. 1.

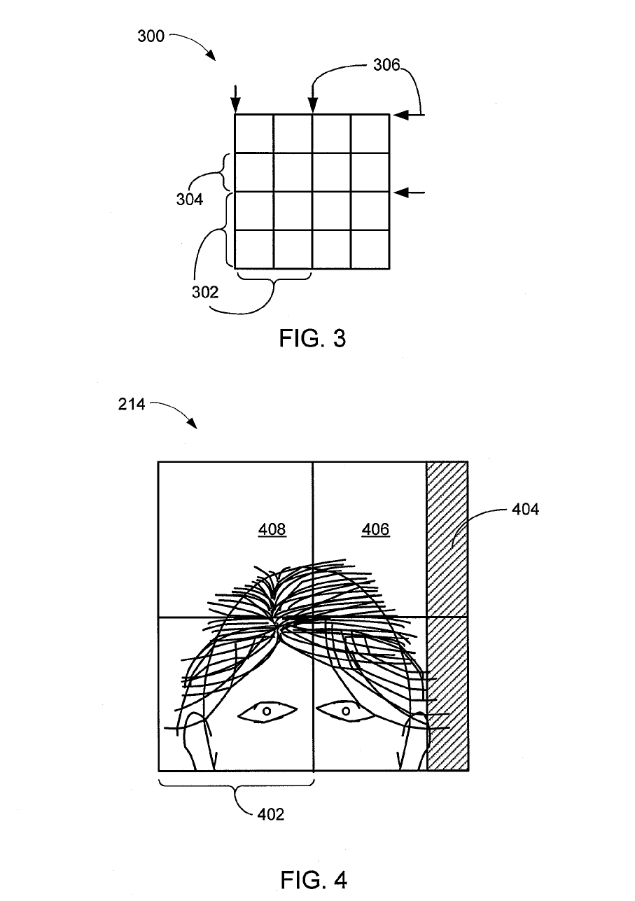

Referring now to FIG. 3, therein is shown a diagram of a macro block 300 in a de-blocking filtering process. The diagram of the macro block 300 depicts the macro block 300 segmented into a 4×4 array having segment boundaries in the vertical and horizontal directions. It has long been known that an 8×8 transform 302 can keep more film grain and texture than a 4×4 transform 304. The film grain and texture relate to the granularity of the media initially used to record the video sequence. The presence of film grain can add realism to plain surfaces. The use of the 8×8 transform 302 helps to preserve some of the realism captured by the original media. Mainly due to this reason, the 8×8 transform 302 was selected into the Advanced Video Coding FR Extension. On the other hand, the 4×4 transform 304 is preferred to be used on the edges of the picture where abrupt changes in texture and luminance create a contrast interference to reduce the “ringing noise”.

When interpreting the lines of the macro block 300 as luma boundaries, for the 4×4 transform 304 all of the lines in the horizontal and vertical directions are filtered. The H.264 specification allows up to three pixels on either side of the boundary to be filtered. Since the boundary lines are four pixels apart, it is a certainty that many of the pixels will be filtered more than once. The filtering removes grain and texture from the picture 202 and the subsequent picture 204 of FIG. 2.

In the 8×8 transform 302, such as a quadrant of the macro block 300, only the horizontal and vertical lines having an arrow 306 are filtered. By applying the same three-pixel overlap on the filtered lines, a few of the pixels in the 8×8 transform 302 are filtered once and a few remain unfiltered. The filter applied to the block boundary is a low pass filter for removing the high frequency content and reducing the blocking artifacts.

Referring now to FIG. 4, therein is shown a diagram of the HVS texture macro block 214 in a human visual system texture analysis process. The diagram of the HVS texture macro block 214 depicts the HVS texture macro block 214 divided into divisions 402, such as quadrants. The divisions 402 are individually analyzed to determine the local variance of the luminance or texture of the content in the HVS texture macro block 214. The HVS texture macro block 214 will be assigned the variance of the luminance of the lowest of the divisions 402.

A background object 404 in the right side of the HVS texture macro block 214 may be detected as the edge 216 of FIG. 2. The detection of the background object 404 will depend on the luminance level in the rest of the HVS texture macro block 214 and the contrast at the border between the background object 404 and the rest of a top right division 406. The HVS texture macro block 214 may be assigned the variance of the luminance of a top left division 408. If the background object 404 was detected, as the edge 216, the analysis of the top right division 406 would shift to the 4×4 transform 304 of FIG. 3.

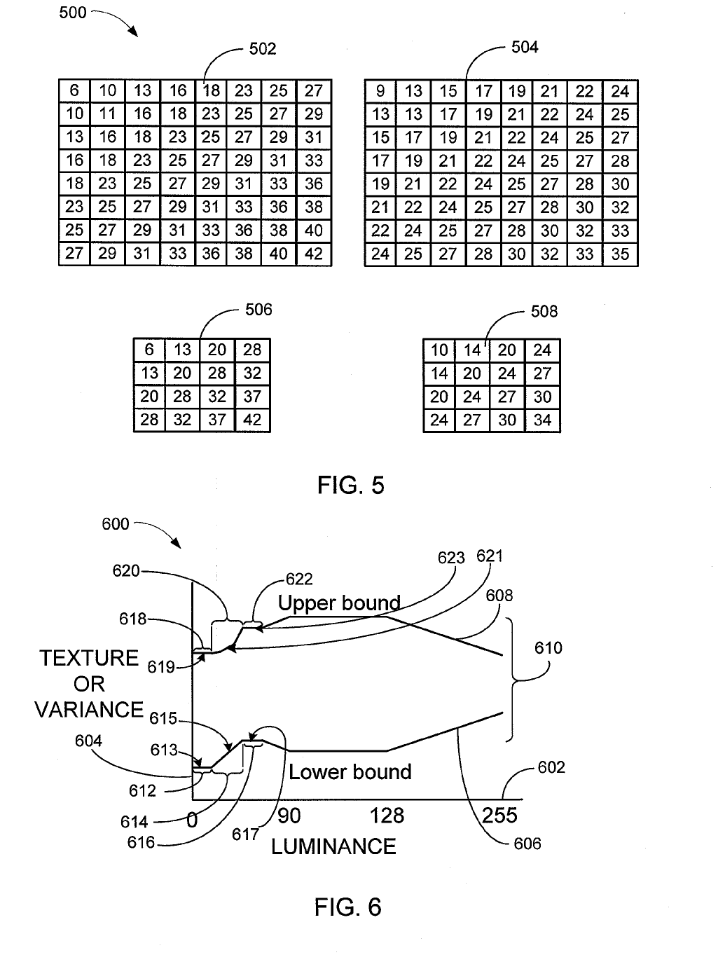

Referring now to FIG. 5, therein is shown a diagram of group of quantization weighting matrices 500 for transforms. The diagram of the group of the quantization weighting matrices 500 depicts an intra light transform 502, such as an Intra 8×8 quantization weighting matrix, an inter light transform 504, such as an Inter 8×8 quantization weighting matrix, an intra heavy transform 506, such as an Intra 4×4 quantization weighting matrix, and an inter heavy transform 508, such as an Inter 4×4 quantization weighting matrix. These default quantization matrices are defined in the H.264/AVC standard. An application may choose to use the quantization weighting matrices 500 from the AVC standard or a custom matrix could be produced and communicated to the decoder at the time the video is to be played and the pictures are reconstructed.

Referring now to FIG. 6, therein is shown a graph of the texture vs. the luminance for a human visual system texture analysis window 600. The graph has an “x-axis” 602 displaying the luminance on a scale of 0 to 255. A “y-axis” 604 displays the texture or variance of the luminance of the macro block under analysis. The scale for the texture is unmarked as the value is dynamic and can have broad excursions over the length of a movie.

As the HVS texture macro block 214 of FIG. 2 is analyzed, a lower bound 606 and an upper bound 608 are dynamically adjusted. If the texture value falls within a window 610 between the upper bound 608 and the lower bound 606 it meets the criteria for the human visual system texture macro block 214.

The QP based adjuster 110 of FIG. 1 adjusts the lower bound by holding the lower bound 606 constant at a first fixed level 613 if the quantization parameter is in a first range 612 of less than 18. If a second range 614 has the quantization parameter between 18 and 38, the lower bound 606 has a linear increase 615. If a third range 616 has the quantization parameter greater than 38, the lower bound 606 is held at a second fixed level 617. The QP based adjuster 110 also adjusts the upper bound 608 by holding the upper bound 608 at an initial value 619 in a first region 618 having the quantization parameter less than 18. In a second region 620 the quantization parameter is between 18 and 38, the upper bound 608 is increased in a three step piece-wise linear function 621. The three step piece-wise linear function 621 approximates a curve with three straight lines. A third region 622 having the quantization parameter greater than 38 holds the upper bound at a secondary fixed value 623.

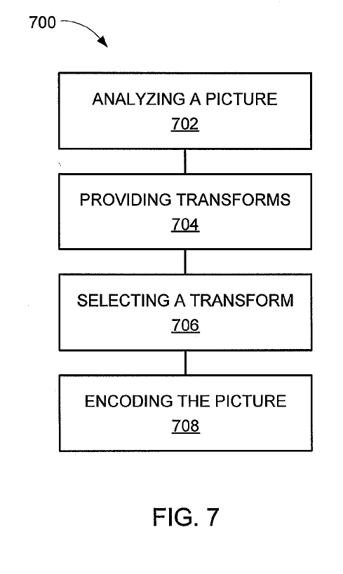

Referring now to FIG. 7, therein is shown a flow chart of a video encoding system 700 for the video encoding system 100 in an embodiment of the present invention. The system 700 includes analyzing a picture in a block 702; providing transforms in a block 704; selecting a transform from the transforms by comparing a luminance characteristic of the picture with a human visual system texture criterion of the picture in a block 706; and applying the transform for encoding and displaying the picture in a block 708.

In greater detail, a system to operate a video encoding system, according to an embodiment of the present invention, is performed as follows:
1. Selecting a block in a picture includes selecting each of the blocks in succession. (FIG. 1)
2. Analyzing a division of the macro block by dividing the block into four 8×8 divisions. (FIG. 1)
3. Detecting a human visual system texture in the division includes detecting a local variance of the luminance. (FIG. 1) and
4. Selecting an 8×8 transform providing sufficient human visual system texture is detected for determining a quantization weighting matrix of the macro block including displaying the human visual system texture in the picture. (FIG. 1)

Thus, it has been discovered that the video coding system of the present invention furnishes important and heretofore unknown and unavailable solutions, capabilities, and functional aspects for encoding video motion pictures. The resulting processes and configurations are straightforward, cost-effective, uncomplicated, highly versatile and effective, can be surprisingly and unobviously implemented by adapting known technologies, and are thus readily suited for efficiently and economically manufacturing video encoding devices fully compatible with conventional manufacturing processes and technologies.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A video encoding system comprising:
analyzing a picture;
providing transforms;
selecting a transform from the transforms by comparing a luminance characteristic of the picture with a human visual system texture criterion of the picture; and
applying the transform for encoding and displaying the picture.

2. The system as claimed in claim 1 further comprising:
providing a block within the picture;
analyzing the block for a human visual system texture; and
identifying the block as being a human visual system texture block, a non-texture block, or an edge block.

3. The system as claimed in claim 1 wherein selecting the transform from the transforms by comparing the luminance includes:
evaluating an average luminance of the picture;
establishing an upper bound and a lower bound based on the average luminance; and
comparing a human visual system texture detected in the picture to the upper bound and the lower bound for selecting the transform.

4. The system as claimed in claim 1 wherein applying the transform includes applying a quantization weighting matrix to the picture.

5. The system as claimed in claim 1 further comprising determining an edge of the picture includes:
evaluating a block within the picture;
dividing the block into divisions;
determining a maximum variance of the luminance characteristic among the divisions;
determining a minimum variance of the luminance characteristic among the divisions; and
dividing the maximum variance of the luminance characteristic by the minimum variance of the luminance characteristic for determining the edge.

6. A video encoding system comprising:
selecting a block in a picture;
analyzing a quadrant of the block;
detecting a human visual system texture in the quadrant; and
comparing the human visual system texture detected in the quadrant with human visual system texture bounds of the picture for displaying the human visual system texture in the picture.

7. The system as claimed in claim 6 further comprising:
detecting an edge of the picture; and
applying a heavy quantization weighting matrix to the block for displaying the edge.

8. The system as claimed in claim 6 further comprising:
determining an upper bound and a lower bound based on the average luminance of the block;
selecting a light transform having the human visual system texture between the lower bound and the upper bound for displaying the human visual system texture in the picture; and
selecting a heavy transform having the human visual system texture above the upper bound or below the lower bound for displaying the human visual system texture in the picture.

9. The system as claimed in claim 6 further comprising:
establishing a lower bound based on the average luminance characteristic in the quadrant; and
wherein detecting the human visual system texture includes:
adjusting the lower bound with a quantization parameter.

10. The system as claimed in claim 6 further comprising:
establishing an upper bound based on the average luminance characteristic in the quadrant; and
wherein detecting the human visual system texture includes:
adjusting the upper bound with a quantization parameter.

11. A video encoding system comprising:
an input sense module for receiving a picture;
a compensation module connected to the input sense module for determining a transform of the picture;
a differentiator module connected to the compensation module for determining an edge of the picture; and
a transform switch connected to the differentiator module for applying the transform to the picture.

12. The system as claimed in claim 11 wherein the input sense module includes:
a visual sensitivity circuit for generating an upper bound and a lower bound based on average luminance of a block in the picture;
a scaling list extractor for extracting a quantization weighting matrix information; and
a human visual system texture detector for comparing an texture output from the human visual system texture detector with the upper bound and the lower bound.

13. The system as claimed in claim 11 wherein the compensation module includes:
a quantization parameter based adjuster coupled to a visual sensitivity circuit of the input sense module;
a human visual system texture boundary circuit coupled to a scale list extractor of the input sense module; and
a human visual system texture comparator coupled to a human visual system texture detector of the input sense module.

14. The system as claimed in claim 11 wherein the differentiator module includes:
an edge differentiator circuit coupled to a human visual system texture comparator of the compensation module; and
an edge comparator coupled to the edge differentiator circuit.

15. The system as claimed in claim 11 wherein the transform switch is coupled to an edge comparator of the differentiator module or a human visual system texture comparator of the compensator module.

16. The system as claimed in claim 11 wherein:
the input sense module for receiving the picture provides a texture output;
the compensation module is connected to the input sense module and the transform switch;
the differentiator module is connected to the compensation module and the transform switch; and
the transform switch is connected to the differentiator module for selecting a transform.

17. The system as claimed in claim 16 further comprising:
a human visual system texture comparator of the compensation module;
an edge differentiator circuit of the differentiator module coupled to the human visual system texture comparator; and
an edge comparator coupled to the edge differentiator circuit.

18. The system as claimed in claim 16 further comprising:
a quantization parameter based adjuster of the compensation module;
a visual sensitivity circuit coupled to the quantization parameter based adjuster; and
a human visual system texture boundary circuit of the compensation module coupled to the quantization parameter based adjuster.

19. The system as claimed in claim 16 further comprising:
a quantization parameter based adjuster of the compensation module;
a visual sensitivity circuit coupled to the quantization parameter based adjuster; and
a human visual system texture boundary circuit of the compensation module coupled to a scaling list extractor of the input sense module.

20. The system as claimed in claim 16 further comprising an edge comparator coupled to a transform switch for invoking an 8×8 quantization weighting matrix or a 4×4 quantization weighting matrix for further processing of the picture.
